(19) United States
(12) Patent Application Publication
(10) Pub. No.: US 2009/0158233 A1
(43) Pub. Date: Jun. 18, 2009

(54) Automatic design method and computer program thereof

(75) Inventor: Tamotsu Kitamura, Nagano-shi (JP)

Correspondence Address: STAAS & HALSEY LLP, SUITE 700, 1201 NEW YORK AVENUE, N.W., WASHINGTON, DC, 20005, US

(73) Assignee: SHINKO ELECTRIC INDUSTRIES CO., LTD, Nagano (JP)

(21) Appl. No.: 12/314,917

(22) Filed: Dec. 18, 2008

(30) Foreign Application Priority Data
Dec. 18, 2007 (JP) 2007-326352

(51) Int. Cl. G06F 17/50

(52) U.S. Cl. 716/13

(57) ABSTRACT

An automatic design method according to the present invention comprises the steps of: grouping rats and tentatively disposed vias by bonding pad groups to be connected, corresponding to the pads that are grouped by four sides of a substrate surface; setting boundary lines to define regions each of which contains any one of the pads and the tentatively disposed vias; checking whether there exist(s) the tentatively disposed via(s) surrounded by bonding pad group(s) that is/are different from the one to which the via(s) in question belong(s) or not; and in a predetermined case, moving and redisposing the tentatively disposed via(s) on respective position(s) each of which is located on a rat to which it is connected and on the boundary line that defines a plurality of adjacent regions containing other vias in the bonding pad group to which the via in question belongs.

### BACKGROUND OF THE INVENTION

1. Field of the Invention

The present invention relates to an automatic design method and a computer program thereof for executing, by an arithmetic processing unit, a design process that designs positions where vias are to be disposed on a substrate surface of a semiconductor package by using a virtual plane corresponding to the substrate surface.

2. Description of the Related Art

In semiconductor integrated circuits such as LSI, PCB and the like, semiconductor packages such as CSP, PBGA, EBGA, HDS and the like, and circuit boards such as MCM/Sip and the like, electrode terminals of semiconductor chips are electrically connected with respective bonding pads of the substrates via respective wires. In trace route design of the semiconductor packages, as set forth in Japanese Unexamined Patent Publication No. 2001-135671, a designer himself/herself designs the semiconductor packages on a virtual plane by trial and error depending on the designers' skill, experience and intuition using a CAD system.

In the design of these various substrates, it is very important how the disposition of vias and trace routes is determined. The trace routes may vary significantly depending on the disposition of the vias. The present applicant has already proposed automatic trace design process that can automatically determine trace route positions by using computation. (See Japanese Unexamined Patent Publication No. 2006-268462.)

Documents such as Kei-Yong Khoo and Jason Cong, “A Fast Multilayer General Area Router for MCM Designs”, IEEE Transaction (Circuit and System, Analog and Digital Signal Processing), vol. 39, November 1992, USA (hereinafter referred to as “Non-patent Document 1”), Tal Dayan and Wayne Wei-Ming Dai, “Layer Assignment for Rubber Band Routing”, UCSC-CRL-93-04, Board of Studies in Computer engineering, University of California Santa Cruz, Jan. 1, 1993, USA (hereinafter referred to as “Non-patent Document 2”) and so on have already proposed techniques for designing the disposition of the vias.

Though several techniques for automatic trace design process that automatically determines the trace route positions by using computation have already been proposed, in relation to the disposition of the vias on the substrate surface, in reality, the designer himself/herself has to design the disposition by trial and error depending on the designers' skill, experience and intuition using a CAD system. Typically, the positions where the vias are to be disposed are determined to some extent by rule of thumb first, and subsequently, the trace routes are determined, but in this case, if an error is found in the trace route design stage, the disposition of the vias has to be reconsidered. In particular, it is difficult to design the disposition of the vias and the accompanying trace routes under the chips and between the balls because too many factors have to be taken into account. Therefore, design man-hours will inevitably be increased, and as a result, manufacturing costs will also be increased.

Further, in the technique as set forth in Non-patent Document 1 that is based on a channel method, trace orientations are limited to angles of multiples of 90 degrees and, therefore, for example, it is not suitable for cases where the traces of the semiconductor packages are arranged in arbitrary forms and orientations.

Still further, in the technique as set forth in Non-patent Document 2, elements that may obstruct the traces such as planes, gates, marks, internal components or other traces, as well as the positions of the vias, balls, bonding pads (F/C) or flip chip pads (F/C) that are to be starting or end points of the traces on the substrates of the semiconductor packages such as PBGA, EBGA and the like are not taken into account at all, and therefore application of this technique is limited.

In view of the above problems, it is an object of the present invention to provide an automatic design method that can easily execute, by an arithmetic processing unit, design process for designing positions where vias are to be disposed on a substrate surface of a semiconductor package by using a virtual plane corresponding to the substrate surface, as well as a computer program for causing a computer to execute this design process.

### SUMMARY OF THE INVENTION

In order to achieve the above object, in the present invention, an automatic design method for executing, by an arithmetic processing unit, a design process that designs positions where vias are to be disposed on a substrate surface of a semiconductor package by using a virtual plane corresponding to the substrate surface comprises: a grouping step of grouping rats and tentatively disposed vias by bonding pads to be connected, corresponding to the bonding pads that are grouped by four sides of the substrate surface of the semiconductor package; a boundary line setting step of setting boundary lines to define regions each of which contains any one of the bonding pads and the tentatively disposed vias; a checking step of checking whether there exist(s) the tentatively disposed via(s) surrounded by bonding pad group(s) that is/are different from the one to which the via(s) in question belong(s) or not; and a disposition step of, if it is determined, in the checking step, that the tentatively disposed via(s) surrounded by the bonding pad group(s) exist(s) singly, moving and redisposing the tentatively disposed via(s) in question on respective position(s) each of which is located on a rat to which the via in question is connected and on the boundary line that defines a plurality of adjacent regions containing other vias in the bonding pad group to which the via in question belongs.

The processes in the steps described above can be implemented in the form of a computer program that can be operated by an arithmetic processing unit such as a computer. Thus, according to the present invention, a computer program for causing a computer to execute a design process that designs positions where vias are to be disposed on a substrate surface of a semiconductor package by using a virtual plane corresponding to the substrate surface comprises: a grouping step of grouping rats and tentatively disposed vias into bonding pad group(s) to be connected, by the bonding pads that are grouped by four sides of the substrate surface of the semiconductor package; a boundary line setting step of setting boundary lines to define regions each of which contains any one of the bonding pads and the tentatively disposed vias; a checking step of checking whether there exist(s) the tentatively disposed via(s) surrounded by bonding pad group(s) that is/are different from the one to which the via(s) in question belong(s) or not; and a disposition step of, if it is determined, in the checking step, that the tentatively disposed via(s) surrounded by the bonding pad group(s) that is/are different from the one to which the via(s) in question belong(s) exist(s) singly, moving and redisposing the tentatively disposed via(s) in question on respective position(s) each of which is located on a rat to which the tentatively disposed via in question is connected and on the boundary line that defines a plurality of adjacent regions containing other vias in the bonding pad group to which the tentatively disposed via in question belongs.

The apparatus for implementing the above process and the creation of a program for causing a computer to execute the above process can be readily implemented by those skilled in the art upon understanding the following detailed description. It is also obvious to those skilled in the art that the program for causing a computer to execute the above process is stored on a recording medium.

### BRIEF DESCRIPTION OF THE DRAWINGS

The present invention will be more clearly understood from the description as set below with reference to the accompanying drawings, wherein:

FIG. 1 is a flow chart showing an operational flow of an automatic design method according to an embodiment of the present invention;

FIG. 2 is a diagram (part 1) describing a specific example to which an automatic design method according to an embodiment of the present invention is applied;

FIG. 3 is a diagram (part 2) describing a specific example to which an automatic design method according to an embodiment of the present invention is applied;

FIG. 4 is a diagram (part 3) describing a specific example to which an automatic design method according to an embodiment of the present invention is applied;

FIG. 5 is a diagram (part 4) describing a specific example to which an automatic design method according to an embodiment of the present invention is applied;

FIG. 6 is a diagram (part 5) describing a specific example to which an automatic design method according to an embodiment of the present invention is applied;

FIG. 7 is a diagram (part 6) describing a specific example to which an automatic design method according to an embodiment of the present invention is applied;

FIG. 8 is a diagram (part 7) describing a specific example to which an automatic design method according to an embodiment of the present invention is applied;

FIG. 9 is a diagram (part 8) describing a specific example to which an automatic design method according to an embodiment of the present invention is applied;

FIG. 10 is a diagram (part 9) describing a specific example to which an automatic design method according to an embodiment of the present invention is applied;

FIG. 11 is a diagram (part 10) describing a specific example to which an automatic design method according to an embodiment of the present invention is applied;

FIG. 12 is a diagram (part 11) describing a specific example to which an automatic design method according to an embodiment of the present invention is applied;

FIG. 13 is a diagram (part 12) describing a specific example to which an automatic design method according to an embodiment of the present invention is applied;

FIG. 14 is a diagram (part 13) describing a specific example to which an automatic design method according to an embodiment of the present invention is applied;

FIG. 15 is a diagram (part 14) describing a specific example to which an automatic design method according to an embodiment of the present invention is applied;

FIG. 16 is a diagram (part 15) describing a specific example to which an automatic design method according to an embodiment of the present invention is applied;

FIG. 17 is a diagram (part 16) describing a specific example to which an automatic design method according to an embodiment of the present invention is applied;

FIG. 18 is a diagram (part 17) describing a specific example to which an automatic design method according to an embodiment of the present invention is applied; and

FIG. 19 is a block diagram showing a configuration of an automatic design apparatus of an embodiment of the present invention that operates according to a program that is stored on a storage medium.

### DESCRIPTION OF THE PREFERRED EMBODIMENTS

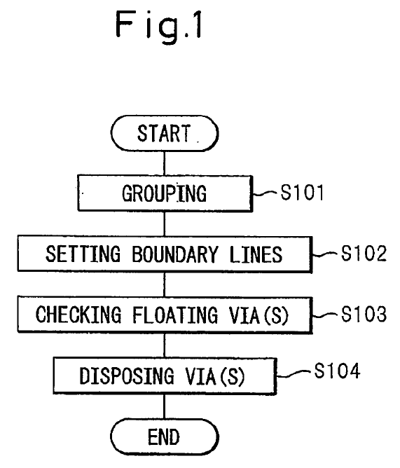

FIG. 1 is a flow chart showing an operational flow of an automatic design method according to an embodiment of the present invention.

In step S101, corresponding to bonding pads that are grouped by four sides of a substrate surface of a semiconductor package, rats and tentatively disposed vias are grouped by the bonding pads to be connected. The substrate of the semiconductor package and a semiconductor chip mounted on the substrate have a quadrilateral shape, and the vias disposed in the vicinity of the contour (or periphery) of the semiconductor chip are connected to the bonding pads that belong to the same regions as the corresponding vias through respective traces. Therefore, the vias are grouped into four regions corresponding to the four sides of the substrate surface of the semiconductor package.

In step S102, boundary lines are set to define regions each of which contains any one of the bonding pads and the tentatively disposed vias. Such boundary lines are set by using Volonoi diagram.

In step S103, it is checked whether there exist(s) the tentatively disposed via(s) surrounded by bonding pad group(s) that is/are different from the one to which the via(s) in question belong(s) or not.

In step S104, if it is determined, in the check in step S103, that the tentatively disposed via(s) surrounded by the bonding pad group(s) exist(s) singly, the tentatively disposed via(s) in question is/are moved and redisposed on respective position(s) each of which is located on a rat to which the via in question is connected and on a boundary line that defines a plurality of adjacent regions containing other vias in the bonding pad group to which the via in question belongs.

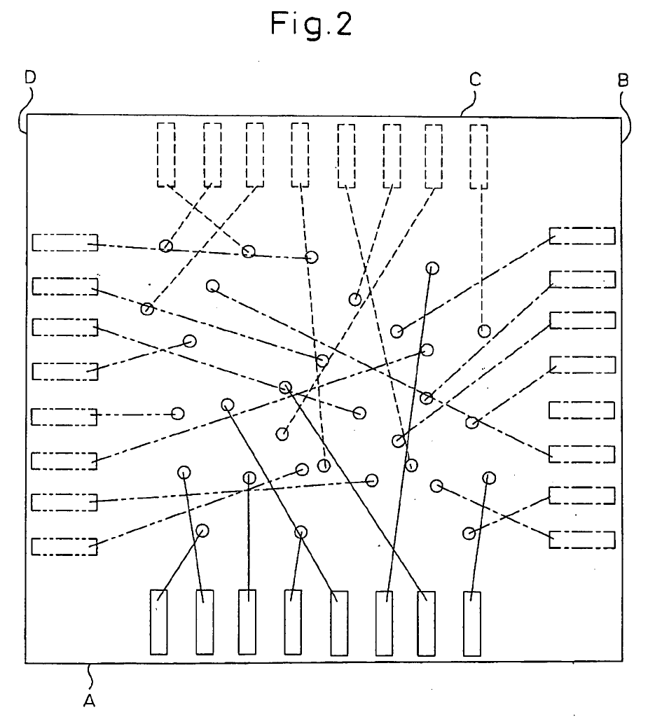

FIGS. 2-18 are diagrams for describing a specific example to which an automatic design method according to an embodiment of the present invention is applied. As an example, a case where rats and vias are tentatively disposed on a substrate surface R of a semiconductor package as shown in FIG. 2 will be described.

First, as shown in FIG. 2, corresponding to bonding pads that are grouped by four sides of substrate surface R of the semiconductor package, the tentatively disposed rats and vias are grouped into bonding pad groups to be respectively connected. The substrate and the semiconductor chip mounted on this substrate have a quadrilateral shape, and the via disposed in the vicinity of the contour (or periphery) of the semiconductor chip are connected to the bonding pads that belong to the same regions as the corresponding vias through respective traces. In this specification, the four sides of substrate surface R refer to side A, side B, side C and side D, and four regions corresponding to these four sides of substrate surface R of the semiconductor package refer to group A, group B, group C and group D, respectively, for convenience. In the subsequent drawings, the vias, rats and bonding pads are represented by circles, line segments and rectangles, respectively. Further, the vias, rats and bonding pads belonging to group A are represented by solid lines; the vias, rats and bonding pads belonging to group B are represented by alternate long and short dashed lines; the vias, rats and bonding pads belonging to group C are represented by broken lines; and the vias, rats and bonding pads belonging to group D are represented by alternate long and two short dashed lines.

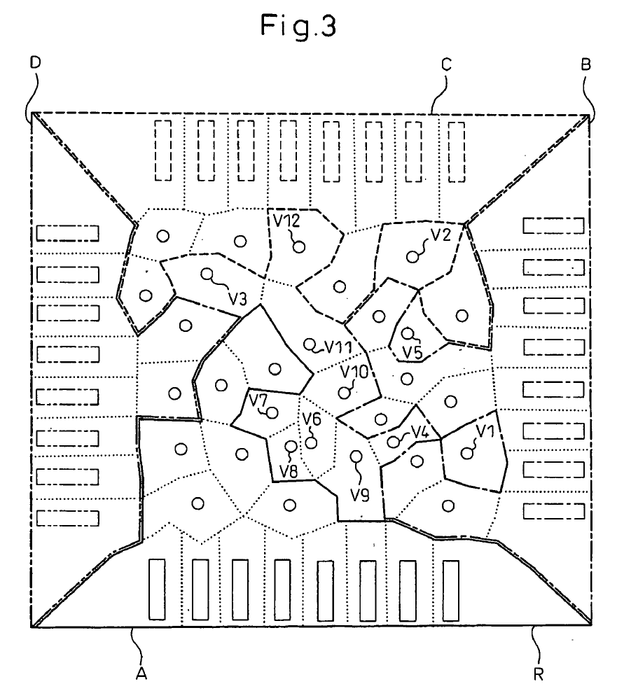

Next, as shown in FIG. 3, boundary lines are set to define regions each of which contains any one of the bonding pads and the tentatively disposed vias. Such boundary lines are set by using Volonoi diagram. In the subsequent diagrams, the boundary lines are represented by dotted lines.

Next, in the state of FIG. 3, it is checked whether there exist(s) the tentatively disposed via(s) surrounded by bonding pad group(s) that is/are different from the one to which the via(s) in question belong(s) or not. In this specification, the tentatively disposed vias surrounded by a bonding pad group that is different from the one to which the vias in question belong are referred to as “floating vias” for convenience.

In the example shown in FIG. 3, via V1 belongs to group A. However, via V1 exists so that it is surrounded not by bonding pad group A to which it belongs but by different bonding pad group B and so that it is not adjacent to other vias belonging to the same group A or, in other words, exists “singly”. Hereinafter, such floating vias are referred to as “floating single vias” for convenience.

Via V2 belongs to group A. However, via V2 is a floating single via that exists so that it is surrounded not by bonding pad group A to which it belongs but by different bonding pad group C and so that it is not adjacent to other vias belonging to the same group A or, in other words, exists “singly”.

Via V3 belongs to group B. However, via V3 is a floating single via that exists so that it is surrounded not by bonding pad group B to which it belongs but by different bonding pad groups C and D and so that it is not adjacent to other vias belonging to the same group B or, in other words, exists “singly”.

Via V4 belongs to group C. However, via V4 exists so that it is surrounded not by bonding pad group C to which it belongs but by different bonding pad group B and so that it is not adjacent to other vias belonging to the same group C or, in other words, exists “singly.”

Via V5 belongs to group D. However, via V5 is a floating single via that exists so that it is surrounded not by bonding pad group D to which it belongs but by different bonding pad groups B and C and so that it is not adjacent to other vias belonging to the same group D or, in other words, exists “singly.”

On the other hand, vias V6 and V7 belong to group C. However, vias V6 and V7 exist so that they are surrounded not by bonding pad group C to which they belong but by different bonding pad group B and so that they are adjacent to other vias belonging to the same group C. Hereinafter, such floating vias are referred to as “floating group vias” for convenience.

Vias V8-V12 belong to group D. However, vias V8-V12 are floating group vias that exist so that they are surrounded not by bonding pad group D to which they belong but by different bonding pad groups A, B and/or C and so that they are adjacent to other vias belonging to the same group D.

As described above, in FIG. 3, vias V1-V12 are floating vias. In step S103 of FIG. 1, it is checked whether there exist(s) the tentatively disposed via(s) surrounded by bonding pad group(s) that is/are different from the one to which the via(s) in question belong(s) or not and, if exist(s), it is checked how such via(s) exist(s). Further, it is also checked how rats intersect each other.

If it is determined, in the check in step S103 of FIG. 1, that the tentatively disposed via(s) is/are surrounded by the bonding pad group(s) different from the one to which the via(s) in question belong(s) and exist(s) singly, in step S104 of FIG. 1, the via(s) is/are redisposed as follows.

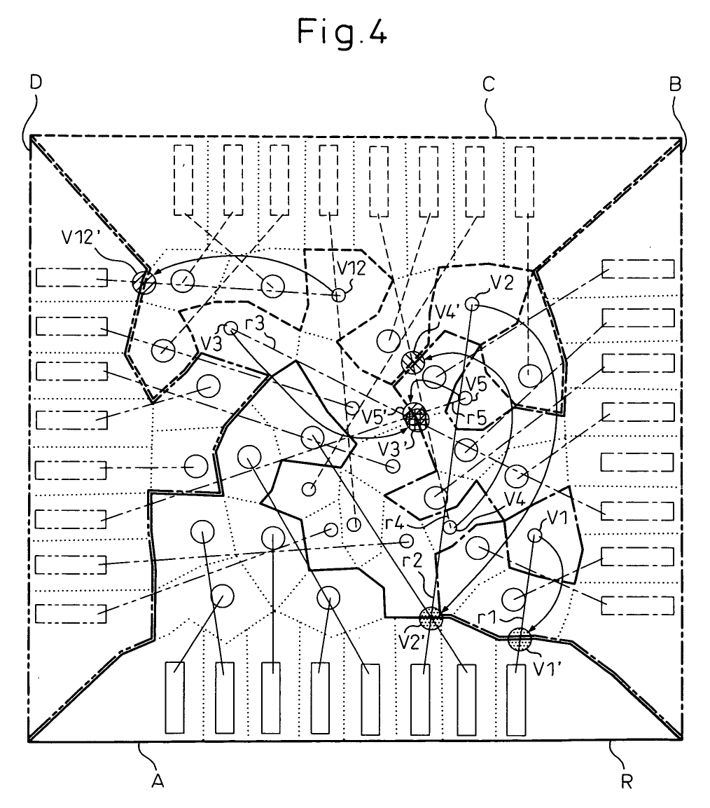

Thus, as shown in FIG. 4, the floating single via(s) that is/are determined to be surrounded by the bonding pad group(s) different from the one to which the via(s) in question belong(s) and to exist singly is/are moved and redisposed on respective position(s) each of which is located on a rat to which the via in question is connected and on a boundary line (represented by a thick line of the corresponding line type) that defines a plurality of adjacent regions containing other vias in the bonding pad group to which the via in question belongs.

Floating single via V1 is moved and redisposed on a position on rat r1 to which floating single via V1 in question is connected and on a boundary line (represented by a thick solid line) that defines a plurality of adjacent regions containing other vias in bonding pad group A to which floating single via V1 in question belongs. The redisposed via is designated by reference numeral V1′.

Floating single via V2 is moved and redisposed on a position on rat r2 to which floating single via V2 in question is connected and on a boundary line (represented by a thick solid line) that defines a plurality of adjacent regions containing other vias in bonding pad group A to which floating single via V2 in question belongs. The redisposed via is designated by reference numeral V2′.

Floating single via V3 is moved and redisposed on a position on rat r3 to which floating single via V3 in question is connected and on a boundary line (represented by a thick alternate long and short dashed line) that defines a plurality of adjacent regions containing other vias in bonding pad group B to which floating single via V3 in question belongs. The redisposed via is designated by reference numeral V3′.

Floating single via V4 is moved and redisposed on a position on rat r4 to which floating single via V4 in question is connected and on a boundary line (represented by a thick broken line) that defines a plurality of adjacent regions containing other vias in bonding pad group C to which floating single via V4 in question belongs. The redisposed via is designated by reference numeral V4′.

Floating single via V5 is moved and redisposed on a position on rat r5 to which floating single via V5 in question is connected and on a boundary line (represented by a thick alternate long and two short dashed line) that defines a plurality of adjacent regions containing other vias in bonding pad group D to which floating single via V5 in question belongs. The redisposed via is designated by reference numeral V5′.

If it is determined, in the check in step S103 of FIG. 1, that a plurality of the tentatively disposed vias exist so that they are surrounded by the bonding pad group(s) different from the one to which the vias in question belong and so that they are adjacent to each other and, at the same time, the rats each connected to the respective tentatively disposed vias in question intersect each other, in step S104 of FIG. 1, the vias are redisposed as follows.

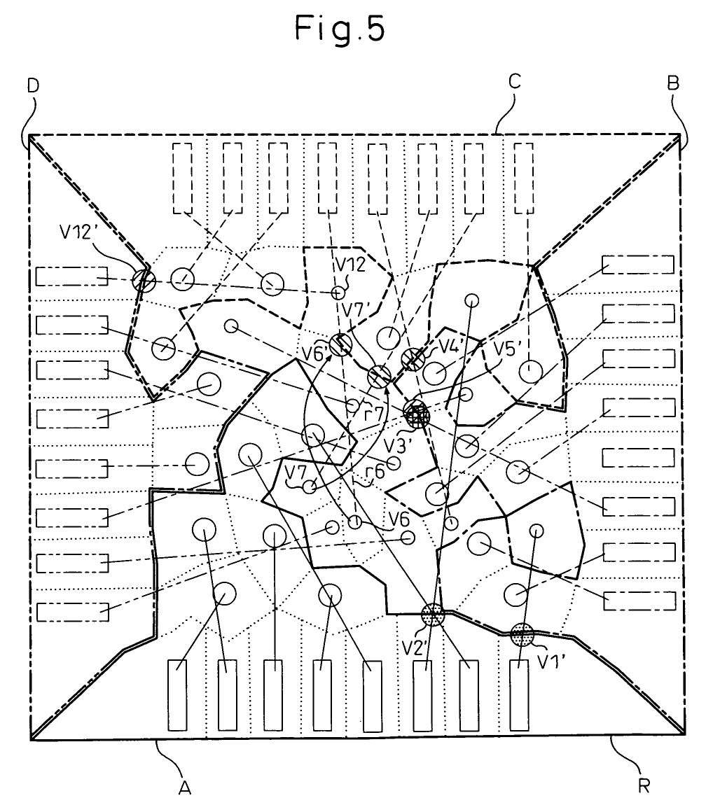

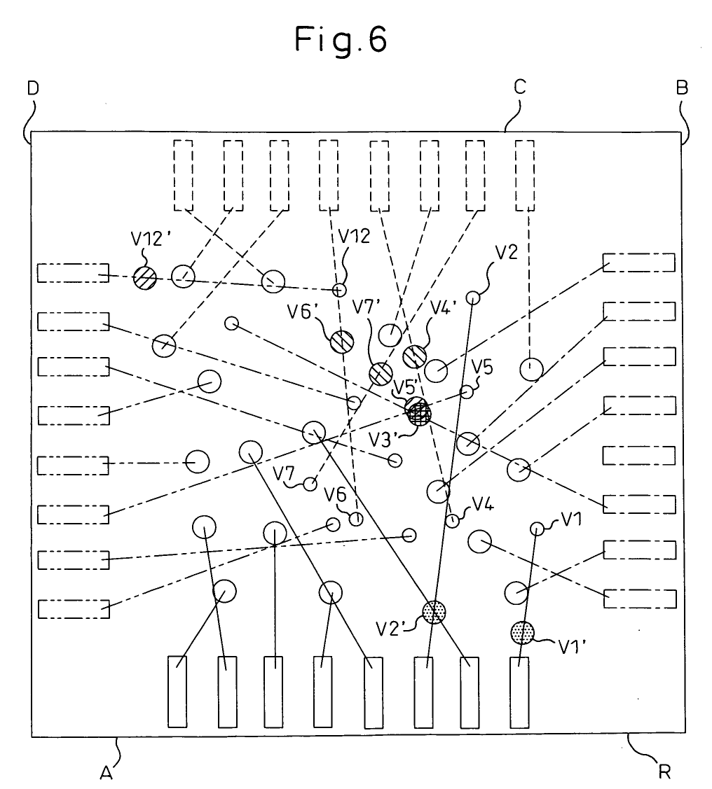

Thus, as shown in FIG. 5, floating vias V6 and V7 exist plurally so that they are surrounded by the bonding pad groups different from the one to which they belong and so that they are adjacent to each other and, at the same time, rats r6 and r7 connected to floating group vias V6 and V7 in question, respectively, intersect each other. Therefore, floating group via V6 is moved and redisposed on a position on rat r6 to which floating group via V6 in question is connected and on a boundary line (represented by a thick broken line in the figure) that defines a plurality of adjacent regions containing other vias in bonding pad group C to which floating group via V6 in question belongs. The redisposed via is designated by reference numeral V6′. Further, floating group via V7 is moved and redisposed on a position on rat r7 to which floating group via V7 in question is connected and on a boundary line (represented by a thick broken line in the figure) that defines a plurality of adjacent regions containing other vias in bonding pad group C to which floating group via V7 in question belongs. The redisposed via is designated by reference numeral V7′. FIG. 6 is a diagram in which the boundary lines in FIG. 5 are omitted for clarity.

If it is determined, in the check in step S103 of FIG. 1, that a plurality of tentatively disposed vias exist so that they are surrounded by the bonding pad group(s) different from the one to which the vias in question belong and so that they are adjacent to each other, but the rats connected to the respective tentatively disposed vias in question do not intersect each other, the vias are not redisposed and kept unmoved.

For example, if it is determined, in the check in step S103 of FIG. 1, that the rats connected to the respective floating group vias intersect each other, in the process in step S104 of FIG. 1, one of the floating group vias that is connected to the rat having the most number of intersections may be redisposed.

Further, for example, if it is determined, in the check in step S103 of FIG. 1, that the rats connected to the respective floating group vias intersect each other and there are two or more rats that have the most number of intersections, in the process in step S104 of FIG. 1, among the floating group vias connected to such rats having the most number of intersections, the floating group via that has the longest tip length may be redisposed.

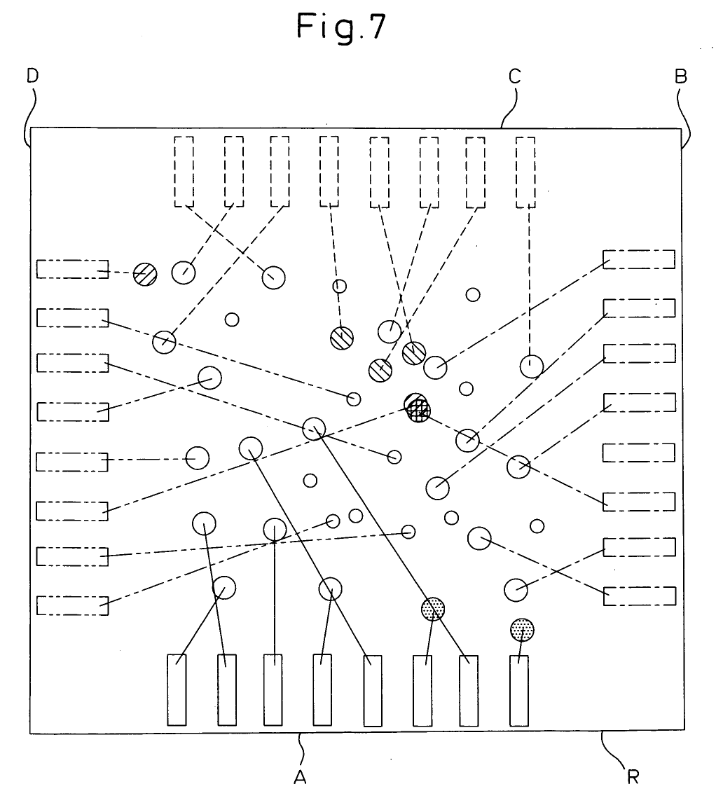

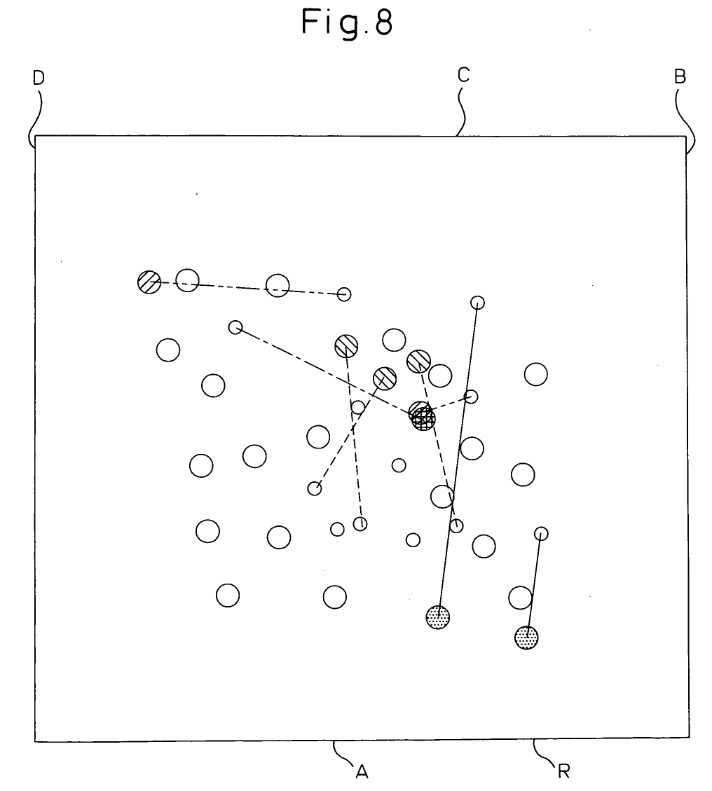

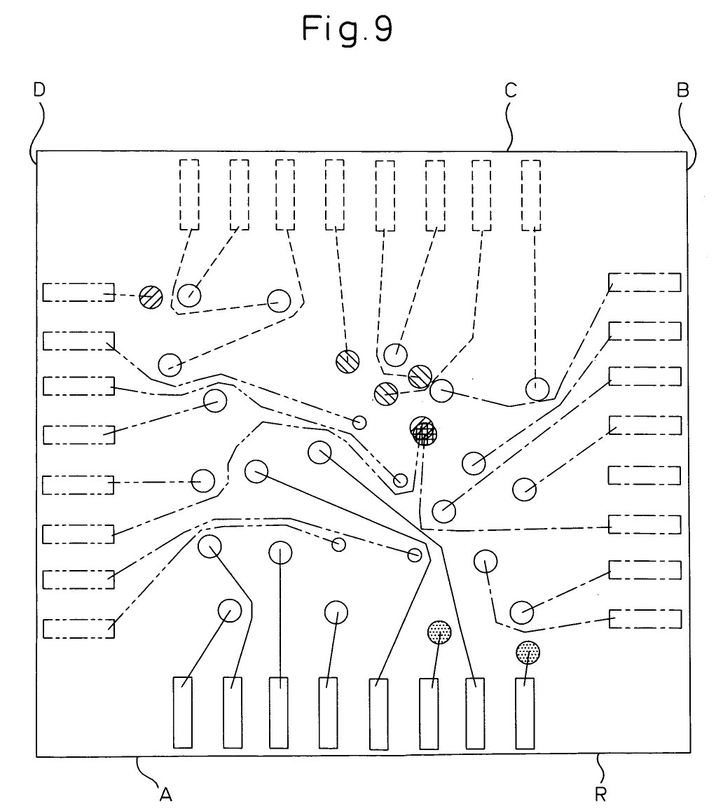

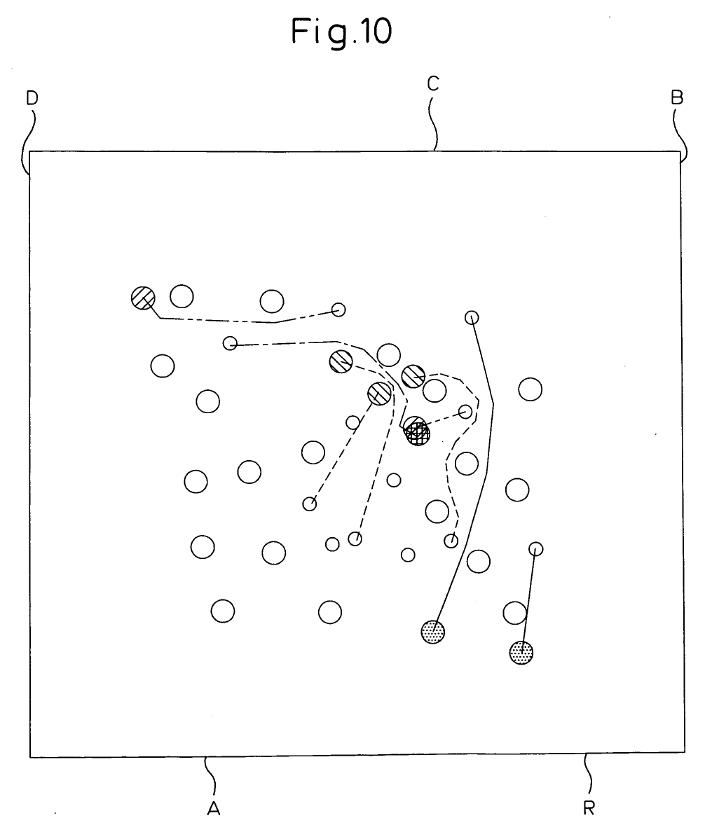

FIGS. 7 and 8 show an example where the vias illustrated in the example shown in FIG. 6 are redisposed and divided into a top layer and an underlying layer of the substrate surface of the semiconductor package, wherein FIG. 7 shows a disposition on the top layer of the substrate surface of the semiconductor package, whereas FIG. 8 shows a disposition on the underlying layer of the substrate surface of the semiconductor package. Further, FIGS. 9 and 10 illustrate actual trace patterns illustrated in the example shown in FIGS. 7 and 8 are modified, taking into consideration clearance between traces, between vias and so on, wherein FIG. 9 shows a disposition on the top layer of the substrate surface of the semiconductor package, whereas FIG. 10 shows a disposition on the underlying layer of the substrate surface of the semiconductor package.

If the rats connected to the vias moved and redisposed on the trace layer under the top layer of the substrate surface of the semiconductor package intersect each other in the region(s) of the bonding pad group(s) to which the vias in question belong, in step S104 of FIG. 1, the vias are redisposed as follows.

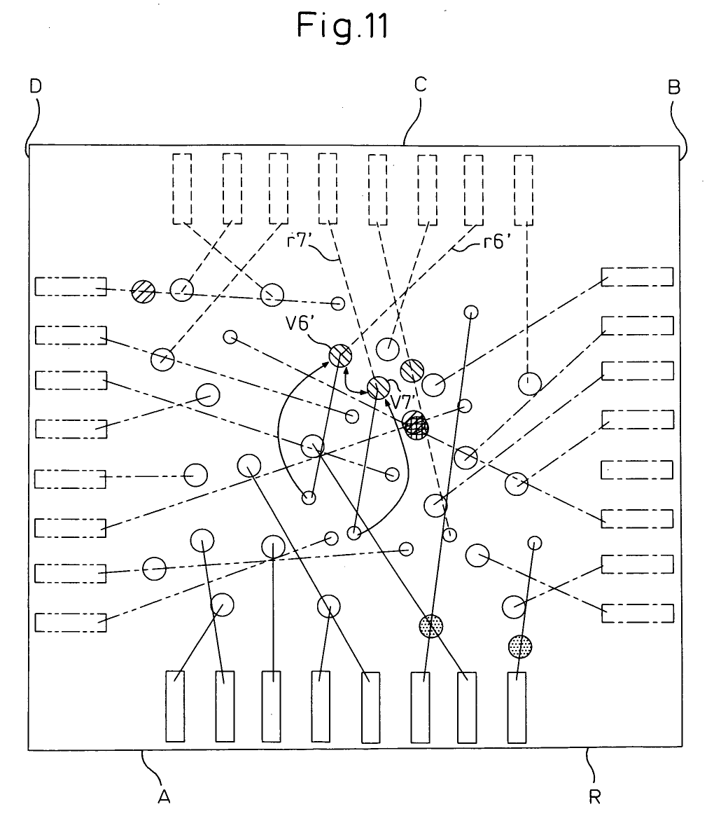

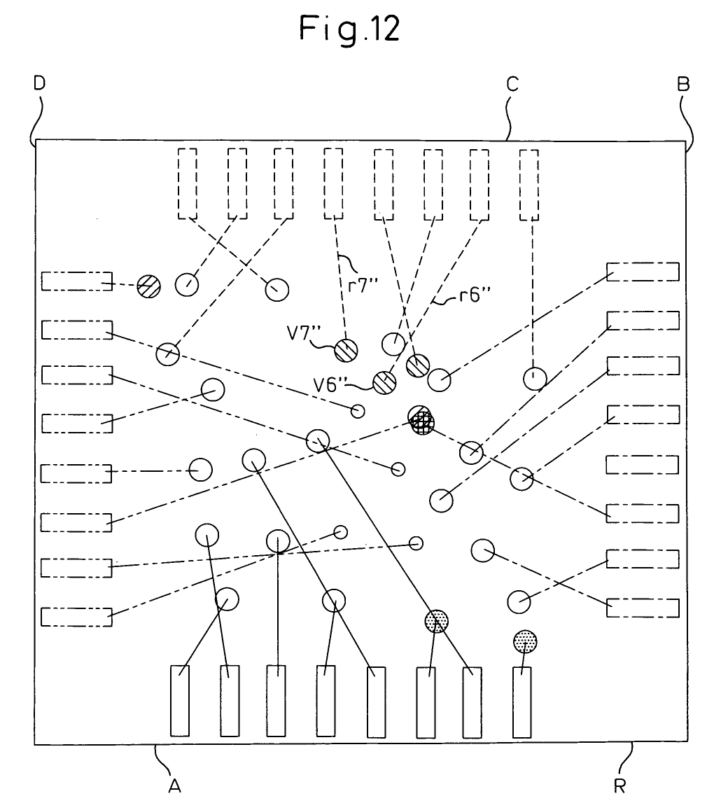

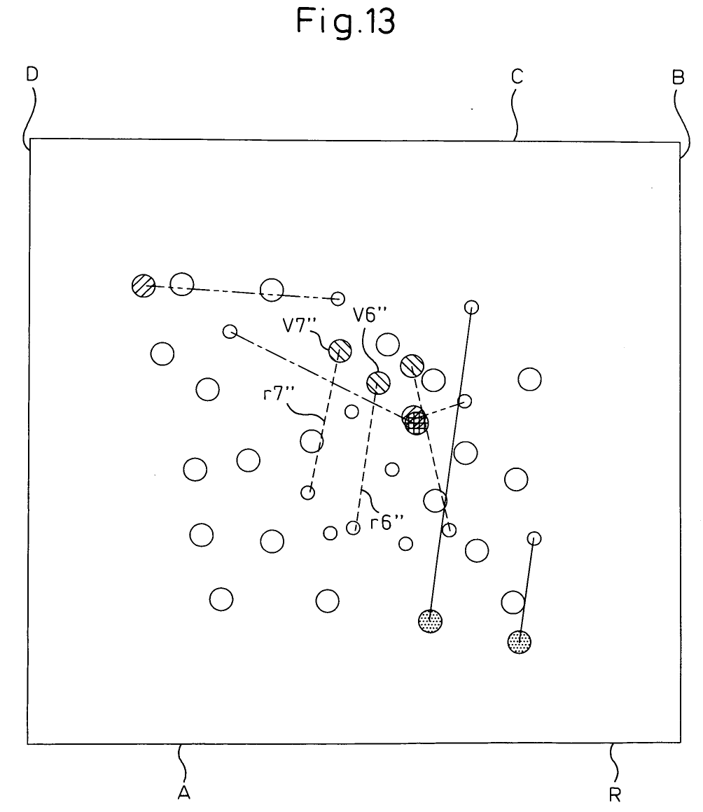

For example, FIG. 8 shows the disposition on the underlying layer where a large number of intersections of the rats are created. More specifically, vias V6′ and V7′ have been moved and redisposed on a trace layer that is located under the top layer of the substrate surface of the semiconductor package, and rats r6′ and r7′ are connected to these vias V6′ and V7′, respectively. These rats r6′ and r7′ intersect each other. In this case, in step S104 of FIG. 1, the vias V6′ and V7′ involving such intersection are redisposed by interchanging their positions with each other, so as to resolve the intersection, as shown in FIG. 11. FIG. 12 shows a disposition on the top layer of the substrate surface of the semiconductor package after resolving the intersection, whereas FIG. 13 shows a disposition on the underlying layer of the substrate surface of the semiconductor package after resolving the intersection. The vias after resolving the intersection are designated by reference numerals V6″ and V7″, and the rats connected to vias V6″ and V7″ are designated by reference numerals r6″ and r7″, respectively.

In the example described above, when the rats connected to the vias moved and redisposed on the trace layer under the top layer of the substrate surface of the semiconductor package intersect each other in the region(s) of the bonding pad group(s) to which the vias in question belong, the vias involving such intersection are redisposed by interchanging their positions with each other, so as to resolve the intersection. As its alternative, in order to resolve the intersection, the vias involving the intersection may be moved and redisposed on the position immediately before the occurrence of this intersection.

When the trace layer under the top layer of the substrate surface of the semiconductor package is a ball layer, in step S104 of FIG. 1, the vias are redisposed as follows.

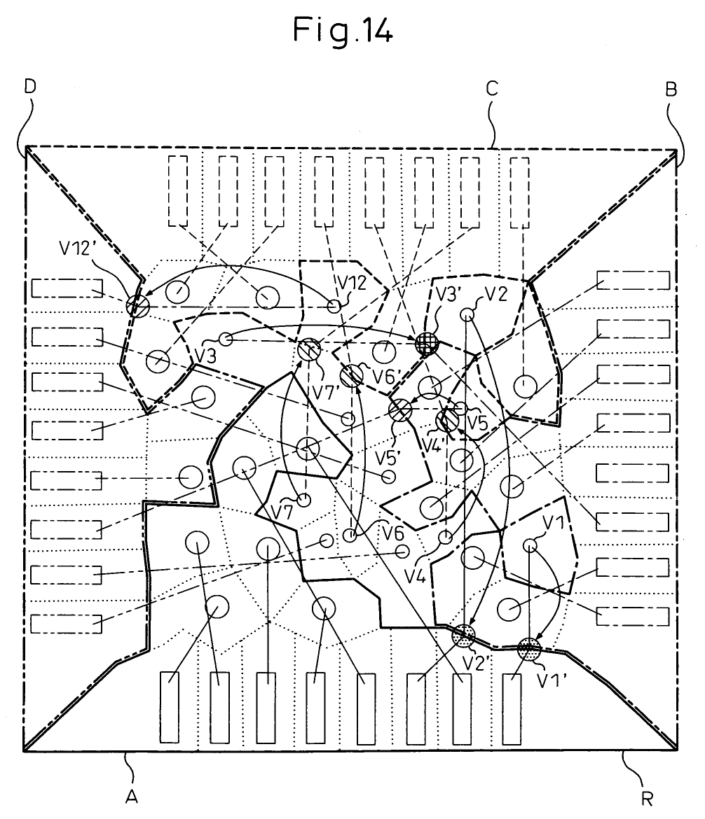

Thus, as shown in FIG. 14, the vias that have been moved and redisposed on the ball layer under the top layer of the substrate surface of the semiconductor package are moved in parallel toward a position of a ball matrix and redisposed on positions on boundary lines (represented by thick lines of the corresponding line types in the figure) that define a plurality of adjacent regions containing other vias in the bonding pad groups to which the vias in question belong.

Via V1 that has been moved and redisposed on the ball layer under the top layer of the substrate surface of the semiconductor package is moved in parallel toward the position of the ball matrix and redisposed on a position on the boundary line (represented by a thick solid line in the figure) that defines a plurality of adjacent regions containing other vias in bonding pad group A to which the via V1 in question belongs. The redisposed via is designated by reference numeral V1.

Via V2 that has been moved and redisposed on the ball layer under the top layer of the substrate surface of the semiconductor package is moved in parallel toward the position of the ball matrix and redisposed on a position on the boundary line (represented by a thick solid line in the figure) that defines a plurality of adjacent regions containing other vias in bonding pad group A to which the via V2 in question belongs. The redisposed via is designated by reference numeral V2′.

Via V3 that has been moved and redisposed on the ball layer under the top layer of the substrate surface of the semiconductor package is moved in parallel toward the position of the ball matrix and redisposed on a position on the boundary line (represented by a thick alternate long and short dashed line in the figure) that defines a plurality of adjacent regions containing other vias in bonding pad group B to which the via V3 in question belongs. The redisposed via is designated by reference numeral V3′.

Via V4 that has been moved and redisposed on the ball layer under the top layer of the substrate surface of the semiconductor package is moved in parallel toward the position of the ball matrix and redisposed on a position on the boundary line (represented by a thick alternate long and short dashed line in the figure) that defines a plurality of adjacent regions containing other vias in bonding pad group B to which the via V4 in question belongs. The redisposed via is designated by reference numeral V4′.

Via V5 that has been moved and redisposed on the ball layer under the top layer of the substrate surface of the semiconductor package is moved in parallel toward the position of the ball matrix and redisposed on a position on the boundary line (represented by a thick alternate long and short dashed line in the figure) that defines a plurality of adjacent regions containing other vias in bonding pad group B to which the via V5 in question belongs. The redisposed via is designated by reference numeral V5′.

Via V6 that has been moved and redisposed on the ball layer under the top layer of the substrate surface of the semiconductor package is moved in parallel toward the position of the ball matrix and redisposed on a position on the boundary line (represented by a thick broken line in the figure) that defines a plurality of adjacent regions containing other vias in bonding pad group C to which the via V6 in question belongs. The redisposed via is designated by reference numeral V6′.

Via V7 that has been moved and redisposed on the ball layer under the top layer of the substrate surface of the semiconductor package is moved in parallel toward the position of ball matrix and redisposed on a position on the boundary line (represented by a thick broken line in the figure) that defines a plurality of adjacent regions containing other vias in bonding pad group C to which the via V7 in question belongs. The redisposed via is designated by reference numeral V7′.

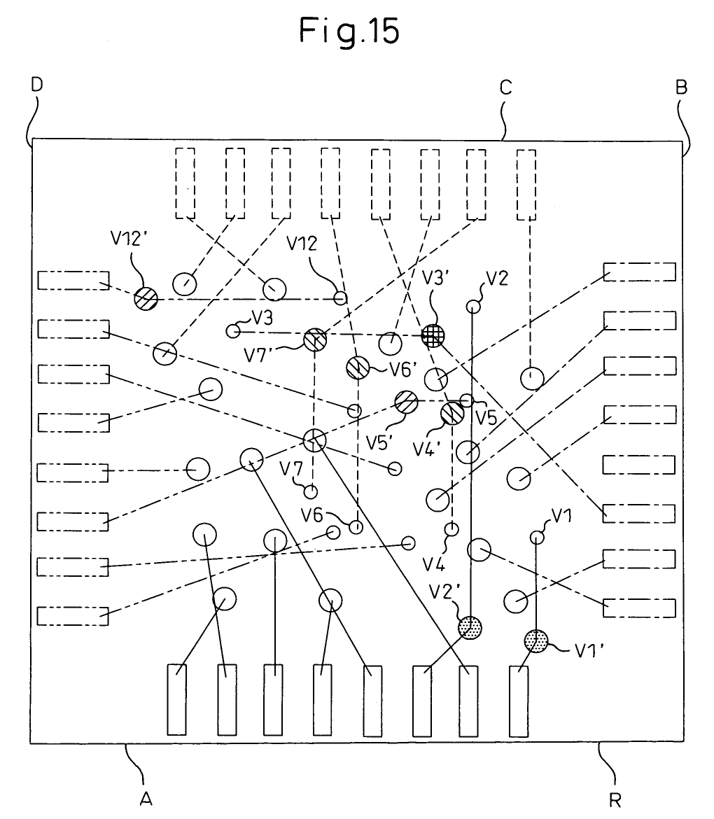

Via V12 that has been moved and redisposed on the ball layer under the top layer of the substrate surface of the semiconductor package is moved in parallel toward the position of the ball matrix and redisposed on a position on the boundary line (represented by a thick alternate long and two short dashed line in the figure) that defines a plurality of adjacent regions containing other vias in bonding pad group D to which the via V12 in question belongs. The redisposed via is designated by reference numeral V12′. FIG. 15 is a diagram in which the boundary lines in FIG. 14 are omitted for clarity.

When one rat that is connected to one via to be moved in parallel and redisposed on the ball layer intersects the other rat that is connected to the other via also to be moved in parallel and redisposed, in order to resolve the intersection, the via in question is moved and redisposed on the position immediately before the occurrence of said intersection. In this intersection resolving process, the intersection may be made on the ball layer avoiding the occurrence of the intersection on the surface layer, or the intersection may be made on the surface layer avoiding the occurrence of the intersection on the ball layer. Trace patterning is more difficult on the ball layer where numerous balls are already disposed and, therefore, it is preferable to avoid the occurrence of the intersection on the ball layer.

When one rat that is connected to one via to be moved in parallel and redisposed on the ball layer intersects the other rat that is connected to the other via also to be moved in parallel and redisposed, the via that is connected to the rat having the most number of intersections may be redisposed so as to resolve the intersection.

Further, for example, when one rat that is connected to one via to be moved in parallel and redisposed on the ball layer intersects the other rat that is connected to the other via also to be moved in parallel and redisposed, if the two rats have the same number of intersections, the via having a longer length between the intersection in question and the ball for such via may be redisposed so as to resolve the intersection.

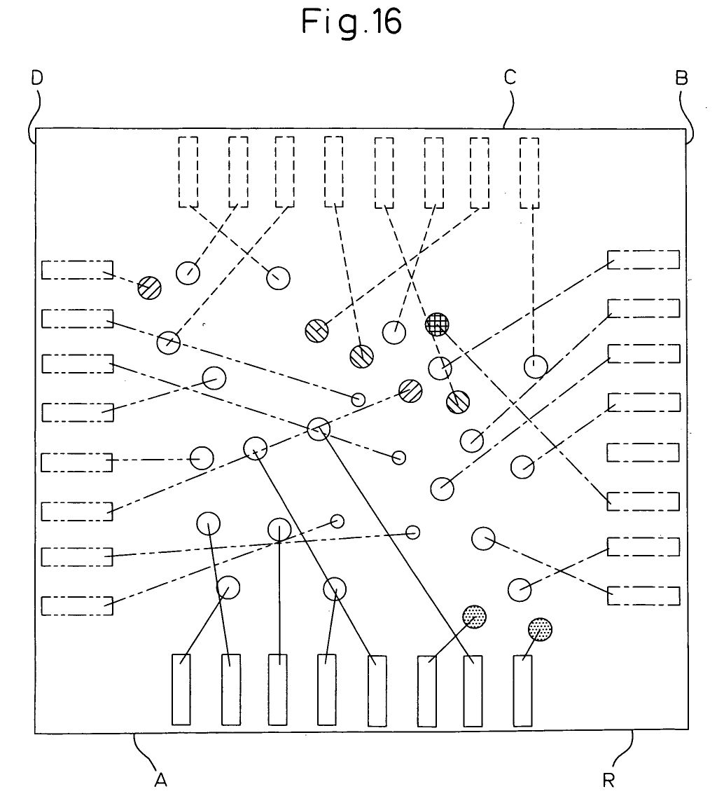

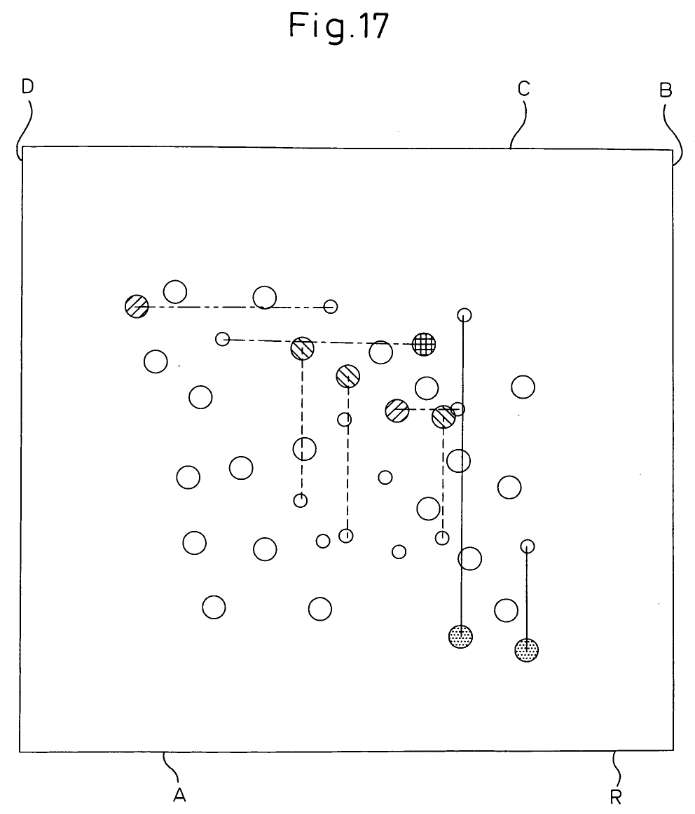

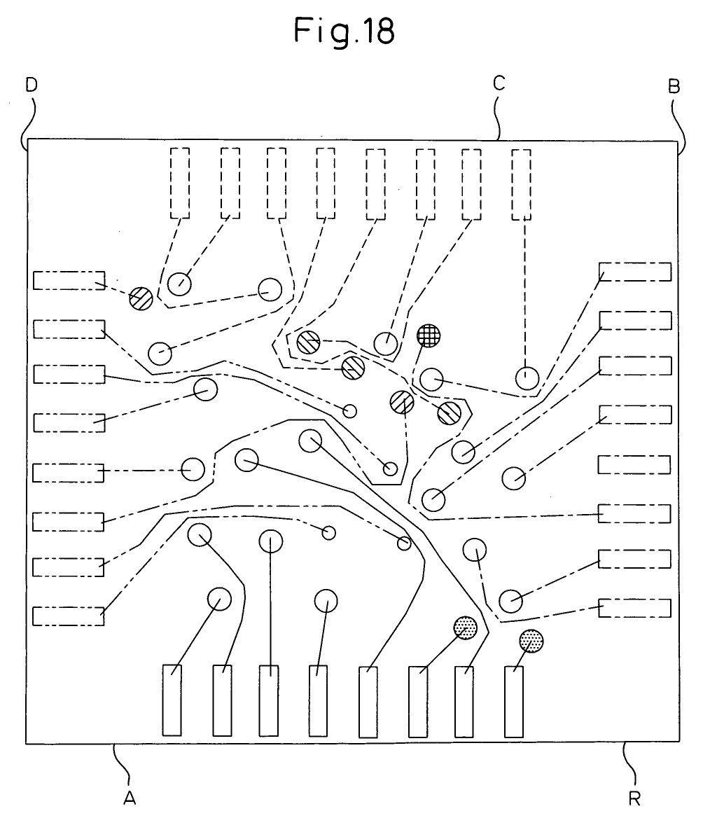

FIGS. 16 and 17 show an example where the vias illustrated in the example shown in FIG. 15 are redisposed and divided into the top layer and the underlying layer of the substrate surface of the semiconductor package, wherein FIG. 16 shows a disposition on the top layer of the substrate surface of the semiconductor package, whereas FIG. 17 shows a disposition on the underlying layer of the substrate surface of the semiconductor package. Further, FIG. 18 illustrates actual trace patterns that is a modification of the example shown in FIG. 16 are modified, taking into consideration clearance between traces, between vias and so on.

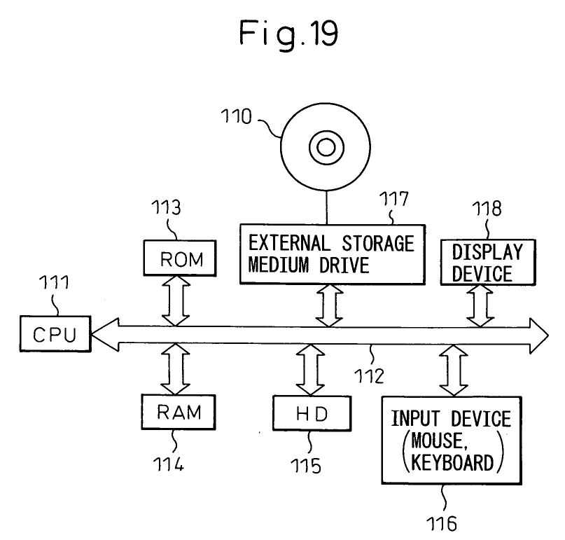

The automatic design method according to the embodiments described above is implemented by using a computer. FIG. 19 is a block diagram showing a configuration of an automatic design apparatus of an embodiment of the present invention that operates according to a program that is stored on a storage medium.

As shown in FIG. 19, a computer program for causing a computer to execute the automatic design process according to the present invention is stored on a storage medium (an external storage medium such as a flexible disk, a CD-ROM, and the like) 110 and, for example, it is installed in a computer configured as described below to operate as the automatic design apparatus.

A CPU 111 controls the automatic design apparatus entirely. This CPU 111 is connected with a ROM 113, a RAM 114, a HD (hard disk drive) 115, an input device 116 such as a mouse, a keyboard and the like, an external storage medium drive 117, and a display device 118 such as a LCD, a CRT, a plasma display, an organic EL and the like through a bus 112. A control program for CPU 111 is stored in ROM 113.

The program for executing the automatic design process according to the present invention (an automatic design process program) is installed (stored) from storage medium 110 on HD 115. Further, in RAM 114, a working area for CPU 111 to execute the automatic design process and an area for storing a portion of the program for executing the automatic design process are secured. Moreover, in HD 115, input data, final data and, further, an OS (operating system) and the like are stored in advance.

First, when the computer is turned on, CPU 111 reads the control program from ROM 110, and further, reads the OS from HD 115 to start the OS. As a result, the computer is ready to install the automatic design process program from storage medium 110.

Next, storage medium 110 is mounted on external storage medium drive 117 and a control command is input from input device 116 to CPU 111 to read the automatic design process program stored in storage medium 110 and store it in HD 115 and the like. Thus, the automatic design process program is installed on the computer.

After that, once the automatic design process program is activated, the computer operates as the automatic design apparatus. The operator can execute the automatic trace shaping process described above by manipulating input device 116 according to working details and procedures through an interaction indicated on display device 118. “Data concerning the optimal trace route” obtained as a result of the process may be, for example, stored on HD 115 for utilization in the future, or may be used to indicate the results of the process on display device 118 visually.

Although the computer program stored in storage medium 110 is installed on HD 115 in the computer of FIG. 19, the present invention is not limited to such implementation and the program may be installed on the computer through an information transmission medium such as a LAN and the like or the program may be installed in advance in HD 115 built in the computer.

According to the present invention, the positions where the vias are to be disposed on the substrate surface of the semiconductor package can be designed on the virtual plane corresponding to the substrate surface efficiently by using the arithmetic processing unit. Thus, automatic design can be made by using the arithmetic processing unit and, therefore, design man-hours, and thus, designers' working hours and burdens on them can be significantly reduced. Further, as a result, manufacturing costs of the semiconductor packages can also be reduced.

The present invention can be applied to semiconductor integrated circuits such as LSI, PCB and the like, semiconductor packages such as CSP, PBGA, EBGA, HDS and the like as well as circuit boards such as MCM/Sip.

What is claimed is:

1. An automatic design method for executing, by an arithmetic processing unit, a design process that designs positions where vias are to be disposed on a substrate surface of a semiconductor package by using a virtual plane corresponding to said substrate surface, the method comprising:
a grouping step of grouping rats and tentatively disposed vias into bonding pad group(s) to be connected, by the bonding pads that are grouped by four sides of the substrate surface of the semiconductor package;
a boundary line setting step of setting boundary lines to define regions each of which contains any one of said bonding pads and said tentatively disposed vias;
a checking step of checking whether there exist(s) said tentatively disposed via(s) surrounded by bonding pad group(s) that is/are different from the one to which the via(s) in question belong(s) or not; and
a disposition step of, if it is determined, in said checking step, that said tentatively disposed via(s) surrounded by said different bonding pad group(s) exist(s) singly, moving and redisposing the tentatively disposed via(s) in question on respective position(s) each of which is located on a rat to which the tentatively disposed via in question is connected and on said boundary line that defines a plurality of adjacent regions containing other vias in the bonding pad group to which the tentatively disposed via in question belongs.

2. A method according to claim 1, wherein, if it is determined, in said checking step, that a plurality of said tentatively disposed vias exist so that they are surrounded by said different bonding pad group(s) and so that they are adjacent to each other and, at the same time, the rats connected to the respective tentatively disposed vias in question intersect each other, said disposition step also moves and redisposes the tentatively disposed vias in question on respective positions each of which is located on a rat to which the tentatively disposed via in question is connected and on said boundary line that defines a plurality of adjacent regions containing other vias in the bonding pad group to which the tentatively disposed via in question belongs.

3. A method according to claim 2, wherein, when it is determined, in said checking step, that a plurality of said tentatively disposed vias exist so that they are surrounded by said different bonding pad group(s) and so that they are adjacent to each other and, at the same time, the rats connected to the respective tentatively disposed vias in question intersect each other, the via that is connected to the rat having the most number of intersections is redisposed in said disposition step.

4. A method according to claim 3, wherein, when it is determined, in said checking step, that a plurality of said tentatively disposed vias exist so that they are surrounded by said different bonding pad group(s) and so that they are adjacent to each other and, at the same time, the rats connected to the respective tentatively disposed vias in question intersect each other, if a plurality of rats have the same number of intersections, the via having the longest tip length is redisposed in said disposition step.

5. A method according to any one of claims 2-4, wherein, when the rats that are connected to the respective vias that have been moved and redisposed intersect each other in the region(s) of the bonding pad group(s) to which the vias in question belong, said disposition step moves and redisposes the vias on a back layer of the substrate surface of the semiconductor package.

6. A method according to claim 5,-further comprising a first intersection resolving step of, when the rats connected to the respective vias moved and redisposed on a trace layer under a top layer of the substrate surface of the semiconductor package intersect each other in the region(s) of the bonding pad group(s) to which the vias in question belong, redisposing the vias involving such intersection by interchanging their positions with each other, so as to resolve said intersection.

7. A method according to claim 5, further comprising a second intersection resolving step of, when the rats connected to the respective vias moved and redisposed on a trace layer under a top layer of the substrate surface of the semiconductor package intersect each other in the region(s) of the bonding pad group(s) different from the one(s) to which the vias in question belong, moving and redisposing the vias in question on the positions immediately before the occurrence of said intersection, so as to resolve said intersection.

8. A method according to claim 7, wherein said trace layer under the top layer of the substrate surface of the semiconductor package is a ball layer,
wherein said disposition step moves the via(s) that has/have been moved and redisposed on said ball layer in parallel toward a position of a ball matrix and redisposes the via(s) on position(s) on said boundary line(s) each defining a plurality of adjacent regions containing other vias in the bonding pad group to which the via in question belongs.

9. A method according to claim 8, further comprising a third intersection resolving step of, when the rat(s) connected to the via(s) moved and redisposed in parallel intersect(s) the rat(s) connected to the other via(s) also moved and redisposed in parallel on said ball layer, moving and redisposing the via(s) in question on the position(s) immediately before the occurrence of said intersection(s), so as to resolve said intersection.

10. A method according to claim 9, wherein, in said third intersection resolving step, the via that is connected to the rat having the most number of intersections is redisposed to resolve said intersection.

11. A method according to claim 10, wherein, in said third intersection resolving step, if a plurality of rats have the same number of intersections, the via having the longest length between the intersection in question and the ball for such via is redisposed to resolve said intersection.

12. A computer program for causing a computer to execute a design process that designs positions where vias are to be disposed on a substrate surface of a semiconductor package by using a virtual plane corresponding to said substrate surface comprises:
a grouping step of grouping rats and tentatively disposed vias by bonding pads to be connected, corresponding to the bonding pads that are grouped by four sides of the substrate surface of the semiconductor package;
a boundary line setting step of setting boundary lines to define regions each of which contains any one of said bonding pads and said tentatively disposed vias;
a checking step of checking whether there exist(s) said tentatively disposed via(s) surrounded by bonding pad group(s) that is/are different from the one to which the via(s) in question belong(s) or not; and
a disposition step of, if it is determined, in said checking step, that said tentatively disposed via(s) surrounded by said different bonding pad group(s) exist(s) singly, moving and redisposing the tentatively disposed via(s) in question on respective position(s) each of which is located on a rat to which the tentatively disposed via in question is connected and on said boundary line that defines a plurality of adjacent regions containing other vias in the bonding pad group to which the tentatively disposed via in question belongs.
